(19) United States
(12) Patent Application Publication
(10) Pub. No.: US 2019/0041053 A1
(43) Pub. Date: Feb. 7, 2019

(54) Pencil Sharpening Device With Flashlight

(71) Applicant: James H. Huizinga, New Lenox, IL (US)

(72) Inventor: James H. Huizinga, New Lenox, IL (US)

(21) Appl. No.: 16/144,157

(22) Filed: Sep. 27, 2018

Related U.S. Application Data
(63) Continuation-in-part of application No. 15/820,394, filed on Nov. 21, 2017.
(60) Provisional application No. 62/425,050, filed on Nov. 21, 2016.

(51) Int. Cl. F21V 33/00; F21L 4/00; B43L 23/08; B43L 23/00

(52) U.S. Cl. CPC F21V 33/0084; F21L 4/005; F21Y 2115/10; B43L 23/008; B43L 23/085

(57) ABSTRACT

A combination pencil sharpening and flashlight device includes an outer shell, a battery, a motor, a cutter head, a top cover, a flashlight head, a pair of switches (one for running the motor and the other for turning the flashlight on and off), a charging port, a charger, a battery meter, and a metal file for sharpening pencil lead to a point. The flashlight head preferably comprises light emitting diodes

### CROSS-REFERENCE TO RELATED APPLICATION

The present application is a continuation-in-part of and claims priority benefits from U.S. nonprovisional patent application Ser. No. 15/820,394 filed on Nov. 21, 2017, entitled “Portable Cordless Heavy Duty Universal Pencil Sharpener and Power Tool with Flashlight” which, in turn, claims priority benefits from U.S. provisional patent application Ser. No. 62/425,050 filed on Nov. 21, 2016, also entitled “Portable Cordless Heavy Duty Universal Pencil Sharpener and Power Tool with Flashlight”. The '394 and '050 applications are hereby incorporated by reference herein in their entireties.

### FIELD OF INVENTION

The present invention relates to mechanical devices, and more particularly to a device to sharpen carpenter's pencils.

### BACKGROUND OF THE INVENTION

Common pencils have a cross section in the shape of a polygonal-sided cylinder. Carpenter pencils have a cross section as a rectangle. Hence, the pencil sharpeners for the former are not suited to the latter. Instead, carpenter's pencils have to be sharpened by a hand, often with a knife or razor blade, and this often results in an irregular point.

Also, much waste is created in whittling the wood away from the core. The present device will allow a pencil to be sharpened faster and have a more precise shape. It can also sharpen other pencils when the cutting head is pulled out of the cutting chamber and replaced with the cutting head appropriate for the pencil being sharpened. Not only is this a universal pencil sharpener, it also is a portable universal power tool, capable of being used as a power screwdriver, sander, drill, or wrench. While working on any object the added benefit, besides the various power tool use, is the illumination of the work area by the flashlight.

### SUMMARY OF THE INVENTION

The above and other shortcomings of existing pencil sharpeners can be overcome by a pencil sharpening device capable of sharpening a pencil with a circular, polygonal, elliptical or rectangular cross-section that can include:
(a) an outer shell;
(b) a top with an opening;
(c) a cutter head housed in the top;
(d) a motor housed in the outer shell that drives rotation of the cutter head; and
(e) a flashlight head with at least one light, the flashlight head being situated at the bottom of the outer shell.

A battery can provide power to the motor and light. In some embodiments, a battery meter can indicate the power level of the battery. The battery can be charged via a charging port.

In some embodiments, a filing surface can be included on the outer shell to file a pencil to a finer point. The filing surface can be made out of metal, sandpaper or other suitable materials.

The pencil sharpener can include switches to operate the motor and the flashlight head.

The cutter head can include a recess with a plurality of teeth to sharpen a pencil inserted through the opening in the top of the sharpener.

In some embodiments, interchangeable sleeves can be inserted into the opening of the top. The sleeves can be used to accept and sharpen a standard No. 2 pencil and/or a carpenter's pencil.

In some embodiments, the pencil sharpening device can include a compressible release tab to remove the cutter head from the device and facilitate attachment of other tools such as a screwdriver, sander, grinder, drill or wrench to the motor. In these embodiments, the motor of the device can be used to drive rotation of such tools.

The above and other shortcomings of existing pencil sharpeners can be overcome by a portable cordless heavy duty universal pencil sharpening device and power tool with flashlight. The device can comprise:
(a) an outer shell;
(b) a battery;
(c) a motor;
(d) a cutter head;
(e) a top cover;
(f) a flashlight head;
(g) a pair of switches, one running the motor and the other turning the flashlight on and off;
(h) a charging port;
(i) a charger;
(j) a battery meter; and
(k) a metal file for sharpening pencil lead to a point.

### BRIEF DESCRIPTION OF THE DRAWINGS

FIG. 1A is a cutaway side view of an embodiment of a universal pencil sharpener.

FIG. 1B is a top view of the universal pencil sharpener of FIG. 1A.

FIG. 2 is a removable power cord that can be used to charge a universal pencil sharpener.

FIG. 3 is a cutaway side view of another embodiment of a universal pencil sharpener.

### DETAILED DESCRIPTION OF ILLUSTRATIVE EMBODIMENT(S)

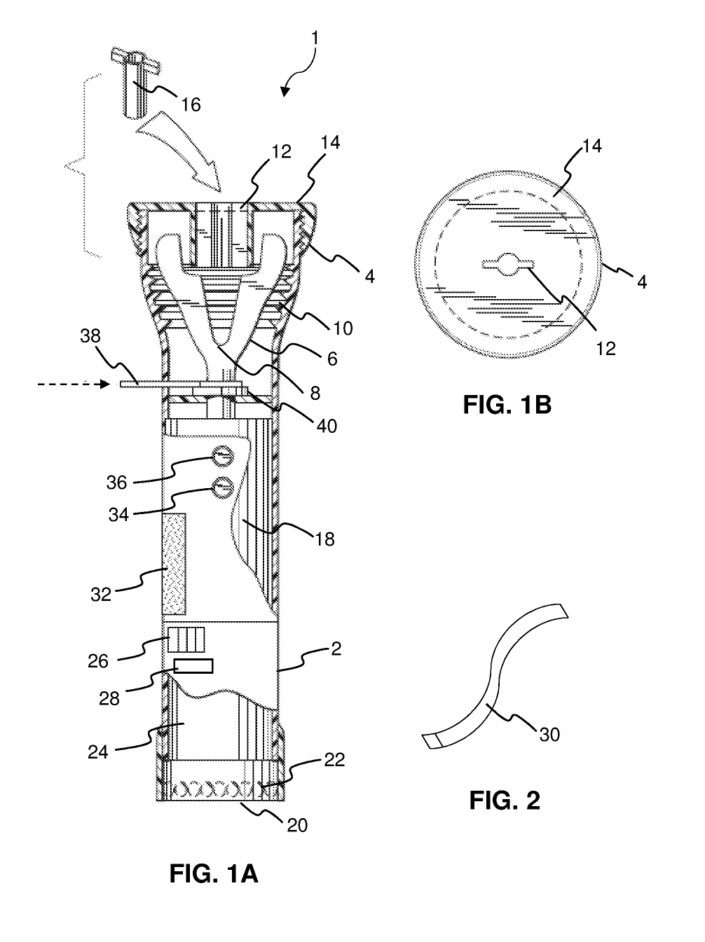

FIGS. 1A and 1B illustrate one embodiment of a cordless, universal pencil sharpener. Sharpener 1 can include outer shell 2 and top 4. Top 4 can be screwed or hinged to outer shell 2. Top 4 can house cutter head 6 with recess 8 and a plurality of cutting teeth 10 configured to accept and sharpen various shaped pencils. In some embodiments, recess 8 is tapered. Top 4 can align pencils in the center of cutter head 6 and hold pencil shavings. In some embodiments, top 4 can be 1 inch (2.54 cm) in diameter and 0.5 inches (1.27 cm) in height. Tools to be sharpened can be inserted through opening 12 located on surface 14 of top 4 (FIG. 1A) to contact cutter head 6. In some embodiments, opening 12 is cylindrical. In some embodiments, opening 12 is rectangular. Various changeable sleeve(s) 16 can be inserted into opening 12 and sized to accommodate various sizes of pencils. Sleeve(s) 16 can have a circular or rectangular outer surface to fit into opening 12. In some embodiments, each sleeve 16 accommodates a different size and/or shape of pencil. In certain embodiments, sleeve 16 accommodates a standard No. 2 pencil. In some embodiments, the shape of opening 12 and/or cutter head 6 is configured to accept and sharpen pencils with a circular, polygonal, elliptical and/or rectangular cross section. In particular embodiments, sharpener 1 can sharpen a carpenter's pencil.

In certain embodiments, opening 112 is a ⅜-inch (0.95 cm) round slot formed from two semicircles. The ends of each semicircle extend outward and connect to create a slot with a length of ⅝-inch (1.6 cm). In these embodiments, opening 112 can sharpen both large (wider than a standard No. 2 pencil) and carpenter's pencils.

Outer shell 2 can house motor 18 that powers cutter head 6. In some embodiments, motor 18 is a DC motor. In at least some embodiments, outer shell 2 is cylindrical. Gasket 40 can be used to seal cutter head 6 and motor 18.

In some embodiments, sharpener 1 can include flashlight head 20 with light(s) 22. In at least some of these embodiments, sharpener 1 can include battery 24 that powers light(s) 22. In some preferred embodiments, battery 24 can be a 12-volt lithium ion battery. In certain embodiments, light(s) 22 are LED lights. In some embodiments, the power or charge level of the battery can be monitored by battery meter 26 present on an exterior surface of pencil sharpener 1. In the embodiment shown in FIG. 1B, battery meter 26 can be a multi-panel meter where illumination of each panel indicates a charge level of battery 24. When all panels are illuminated, the battery is fully charged. In some embodiments, flashlight head 20 can be 1 inch (2.54 cm) in diameter and ⅛-inch (0.32 cm) in height.

In certain embodiments, sharpener 1 includes charging port 28 that functions to charge battery 24 via power cord 30 (FIG. 2). In some embodiments, charging port 28 is a USB port and power cord 30 is a USB cable.

In some embodiments, sharpener 1 can include filing surface 32 that functions to sharpen a pencil or tool to a finer point and/or desired shape. Filing surface 32 can be made out of suitable material including but not limited to metal and/or sandpaper. In some embodiments, filing surface 32 can be 2 inches (5.08 cm) in length and a ½-inch (1.27 cm) in width.

In some embodiments, light(s) 22 of flashlight head 20 are operated by flashlight on/off switch 34.

In some embodiments, motor 18 is operated by sharpener on/off switch 36.

In some preferred embodiments, the height of sharpener 1 can be 7 inches (17.8 cm) and the diameter of flashlight head 20 can be 1⅜ inches (3.5 cm).

In some embodiments, top 4 and/or cutter head 6 are removable and interchangeable with other suitable attachments, such as other cutter heads or tools. Top 4 can be removed and cutter head 6 can be released using compressible release tab 38 (indicated by the dashed arrow in FIG. 1B).

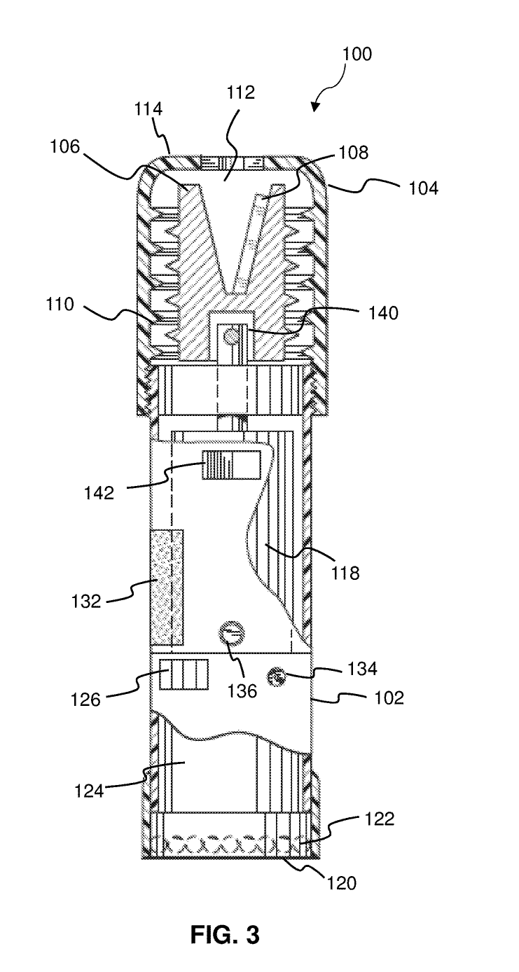

Turning to FIG. 3, another embodiment of a cordless, universal pencil sharpener is shown. Sharpener 100 can include outer shell 102 and top 104. Top 104 can be screwed or hinged to outer shell 102. Top 104 can house cutter head 106 with blade 108 and a plurality of cutting teeth 110 configured to accept and sharpen various shaped pencils. In some embodiments, at least part of cutter head 106 is angled, recessed or tapered. Top 104 can align pencils in the center of cutter head 106 and hold pencil shavings. Tools to be sharpened can be inserted through opening 112 located on surface 114 of top 104 to contact blade 108 and/or cutting teeth 110. In some embodiments, cutter head 106 and opening 112 can be sized to accommodate various sizes of pencils. In some embodiments, top 104 and/or cutter head 106 are removable and interchangeable with other suitable attachments. In some embodiments, the shape of opening 112 and/or cutter head 106 is configured to accept and sharpen pencils with a circular, polygonal, elliptical and/or rectangular cross section.

Outer shell 102 can house motor 118 that powers cutter head 106. In some embodiments, motor 118 is a DC motor. In at least some embodiments, outer shell 102 is cylindrical. In some embodiments, cutter head 106 is configured to rotate in a clockwise or counterclockwise direction by drive shaft 140 and motor 118. The directionality of cutter head 106 rotation can be controlled by forward/reverse motor switch 142. In some embodiments, drive shaft 140 is a ¼-inch (0.64 cm) square drive shaft.

In some embodiments, sharpener 100 can include flashlight head 120 with light(s) 122. In at least some of these embodiments, sharpener 100 can include battery 124 that powers light(s) 122. In a preferred embodiment, battery 124 can be a 12-volt lithium ion battery. In certain embodiments, light(s) 122 are LED lights. In some embodiments, the power or charge level of the battery can be monitored by battery meter 126 present on an exterior surface of pencil sharpener 100. In the embodiment shown in FIG. 3, battery meter 126 can be a multi-panel meter where illumination of each panel indicates a charge level of battery 124. When all panels are illuminated, the battery is fully charged.

In certain embodiments, sharpener 100 includes charging port 134 that functions to charge battery 124 via power cord or USB cable. In some embodiments, charging port 134 is a USB port.

In some embodiments, sharpener 100 can include filing surface 132 that functions to sharpen a pencil or tool to a finer point and/or desired shape. Filing surface 132 can be made out of suitable material including but not limited to metal and/or sandpaper.

In some embodiments, light(s) 122 of flashlight head 120 can be operated by flashlight on/off switch 136.

Certain components of the sharpener, such as the outer shell, cutter head and/or top can be made of conventional materials including, but not limited to, plastic, aluminum or metal.

The components of the present device can include:
(a) An outer shell that houses the inner components. In some embodiments, the outer shell is round and/or made from heavy duty plastic or aluminum. In some preferred embodiments, the outer shell can be 7 inches (17.8 cm) tall and 1 inch (2.5 cm) wide.
(b) A lithium ion battery that functions to run the motor. In some embodiments, the battery can have a diameter of 1 inch (2.5 cm) and a height of 2 inches (5.1 cm).
(c) A DC motor that functions to run the cutter head. In some embodiments, the motor can have a diameter of 1 inch (2.5 cm) and a height of 2 inches (5.1 cm). In certain embodiments, the motor is made of steel.
(d) A cutter head that functions to sharpen pencils. In some embodiments, the cutter head can be tapered and equipped with razors and/or cutting teeth.. The cutter head can be made of suitable materials such as plastic or aluminum.
(e) A top cover that functions to hold shavings and align pencils in the center of the cutter head. In some embodiments, the top cover has a diameter of 1 inch (2.5 cm) and a height of ½ inch (1.27 cm). The top can be screwed or hinged to the outer shell. In some embodiments, the top cover can include a rectangular and round hole in the center to align both standard and carpenter's pencils in the cutter head. The top can be made of suitable materials such as plastic or aluminum.
(f) An LED flashlight head positioned at the bottom of the device that functions to light up dark workplaces. In some embodiments, the flashlight head can have a diameter of 1 inch (2.5 cm) and a height of ⅛ inch (0.32 cm). The flashlight head can be made of suitable materials such as plastic or aluminum. The flashlight head can include 10-15 LED lights and include a clear plastic lens.
(g) A first switch that runs the motor and a second switch that powers the flashlight.
(h) A charging port that functions to recharge the battery. In some embodiments, the charging port is made of metal and has a diameter of ⅛ inch (0.32 cm).
(i) A charger that functions to recharge the battery. In some embodiments, the charger can be a 110 volt to 12 volt.
(j) A battery meter that functions to monitor the battery life of the device. In some embodiments, the battery meter can be 3 round LED lights, with three lights indicating the device is fully charged and one light indicating the device needs charging.

(k) A file that functions to sharpen the pencil lead to a finer point. It can be located on the side of the outer shell. The shape can be rectangular and/or rounded. In some embodiments, the file surface has a length of 2 inches (5.1 cm) and a width of ½ inch (1.3 cm). The file can be made of suitable materials such as metal or sandpaper.

### Operation of the Present Device

Like an ordinary motor-driven pencil sharpener, a user inserts a pencil into the slot at the top of the present device, and the motor turns on, driving the sharpening head around the pencil. To use the present device for an ordinary pencil, a user can interchange cutting heads by pulling out the head last used and inserting the one desired for any sized pencil. The cap is periodically unscrewed to empty out the shavings. To be used as other than a pencil sharpener, a user can actuate the release mechanism (see FIG. 1B), remove the cutting head and insert the appropriate attachment for the present device so it can be used as a power screwdriver, sander, grinder, drill, or wrench. A “reverse motor” button (not shown) can allow the wrench or other attachment to turn in the opposite direction.

In one modality there are other uses for the present device when the appropriate adapters are installed. For example, the motor, with the flashlight attachment, can be used to drive other tools, including but not limited to screwdriver blades, wrench sockets, abrading stones, or sanders.

This includes but is not limited to the type of material, configuration, color, weight, size, shape, or other form, as well as use, so long as the central purpose described above is preserved.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A pencil sharpening device comprising:
(a) an outer shell;
(b) a removable top with a first opening formed therein, wherein said removable top is attached to said outer shell;
(c) a cutter head housed in said removable top;
(d) a motor housed in said outer shell, wherein said motor drives rotation of said cutter head; and
(e) a flashlight head with at least one light, wherein said flashlight head is situated at the bottom of said outer shell, opposite said first opening of said removeable top,
wherein said pencil sharpening device is configured to sharpen a pencil with a circular, polygonal, elliptical or rectangular cross-section.

2. The pencil sharpening device of claim 1, further comprising:
(f) a battery that provides power to said motor and said at least one light.

3. The pencil sharpening device of claim 2, further comprising:
(g) a battery meter situated on said outer shell to indicate a power level of said battery.

4. The pencil sharpening device of claim 3, further comprising:
(h) a charging port to charge said battery, wherein said charging port can be connected to a removable power cord.

5. The pencil sharpening device of claim 1, further comprising:
(f) a filing surface situated on said other shell, wherein said filing surface is used to sharpen said pencil to a finer point.

6. The pencil sharpening device of claim 5, wherein said filing surface is comprised of metal.

7. The pencil sharpening device of claim 5, wherein said filing surface is comprised of sandpaper.

8. The pencil sharpening device of claim 1, further comprising:
(f) a first switch, wherein said first switch operates said motor; and
(g) a second switch, wherein said second switch operates said at least one light of said flashlight head.

9. The pencil sharpening device of claim 1, wherein said at least one light comprises a plurality of LED lights.

10. The pencil sharpening device of claim 1, wherein said cutter head comprises a recess with a plurality of cutting teeth configured to accept and sharpen said pencil.

11. The pencil sharpening device of claim 10, wherein said recess of said cutter head is aligned with said first opening of said removable top.

12. The pencil sharpening device of claim 11, wherein said pencil is sharpened by inserting said pencil through said first opening of said removable top and into said recess of said cutter head to contact said plurality of cutting teeth.

13. The pencil sharpening device of claim 1, further comprising:
(f) a removable sleeve insertable into said first opening of said removable top.

14. The pencil sharpening device of claim 13, wherein said sleeve is configured to accept a standard No. 2 pencil.

15. The pencil sharpening device of claim 13, wherein said sleeve is configured to accept a carpenter's pencil.

16. The pencil sharpening device of claim 1, further comprising:
(f) a release mechanism that can be used to remove said cutter head from said device.

17. The pencil sharpening device of claim 16, wherein said release mechanism is a compressible release tab.

18. The pencil sharpening device of claim 17, wherein removal of said removable top and said cutter head allows for attachment of a plurality of tools such that said plurality of tools can be powered by said motor.

19. The pencil sharpening device of claim 18, wherein said motor can be configured to rotate clockwise or counter-clockwise.

20. The pencil sharpening device of claim 19, wherein said plurality of tools is a screwdriver, sander, grinder, drill, or wrench.
